(19) United States
(12) Patent Application Publication
(10) Pub. No.: US 2025/0392105 A1
(43) Pub. Date: Dec. 25, 2025

(54) SPARK PLUG

(71) Applicant: Niterra Co., Ltd., Nagoya-shi, Aichi (JP)

(72) Inventors: Kazuki TANAKA, Nagoya-shi, Aichi (JP); Kazuki KOIKE, Nagoya-shi, Aichi (JP); Tomoki NAKAGAWA, Nagoya-shi, Aichi (JP); Takao SAKAI, Nagoya-shi, Aichi (JP)

(73) Assignee: Niterra Co., Ltd., Nagoya-shi, Aichi (JP)

(21) Appl. No.: 18/727,445

(22) PCT Filed: Nov. 28, 2022
(86) PCT No.: PCT/JP2022/043690

§ 371 Date: Mar. 7, 2025

(30) Foreign Application Priority Data
Jan. 11, 2022 (JP) 2022-002471

(51) Int. Cl. H01T 13/39; H01T 13/04; H01T 13/34

(52) U.S. Cl. CPC H01T 13/39; H01T 13/04; H01T 13/34

(57) ABSTRACT

A spark plug includes: an insulator having an axial hole along an axial line; a center electrode provided on a front end side in the axial hole; a metal terminal provided on a rear end side in the axial hole; and a connection portion electrically connecting the center electrode and the metal terminal in the axial hole. The metal terminal has a head portion located at a rear end of the insulator, and a shaft portion located in the axial hole adjacently to a front end of the head portion. The shaft portion is thinner than the head portion, and at least a front end of the shaft portion contacts with the connection portion. The metal terminal contains 97 wt % or more of Fe and 0.20 to 0.28 wt % of C. A length along the axial line of the shaft portion is not greater than 60 mm.

### FIELD OF THE INVENTION

The present invention relates to a spark plug having a metal terminal provided in an insulator.

### BACKGROUND OF THE INVENTION

There is known a spark plug that includes an insulator having an axial hole penetrating from a front end to a rear end, a center electrode provided on a front end side in the axial hole, a metal terminal provided on a rear end side in the axial hole, and a connection portion electrically connecting the center electrode and the metal terminal in the axial hole (Japanese Patent Application Laid-Open (kokai) No. H10-144448). In the conventional structure disclosed in Patent Document 1, the metal terminal has a head portion located at the rear end of the insulator, and a shaft portion located in the axial hole adjacently to a front end of the head portion, and the shaft portion contacts with the connection portion. The material of the metal terminal is low-carbon steel in which the content of C (carbon) is not more than 0.3 wt %.

As the amount of C in carbon steel becomes smaller, the ductility of carbon steel becomes greater, but the yield strength (proof stress) and the tensile strength thereof become smaller. Therefore, in the conventional structure, in a case where the amount of C contained in the metal terminal is small, when a compressive force in the axial-line direction applied to the shaft portion of the metal terminal becomes great, flexural buckling might occur in the shaft portion.

The present invention has been made to solve the above problem, and an object of the present invention is to provide a spark plug that can suppress occurrence of flexural buckling of a shaft portion.

### SUMMARY OF THE INVENTION

To attain the above object, a spark plug of the present invention includes: an insulator having an axial hole penetrating from a front end to a rear end along an axial line; a center electrode provided on a front end side in the axial hole; a metal terminal provided on a rear end side in the axial hole; and a connection portion electrically connecting the center electrode and the metal terminal in the axial hole. The metal terminal has a head portion located at a rear end of the insulator, and a shaft portion located in the axial hole adjacently to a front end of the head portion. The shaft portion is thinner than the head portion, and at least a front end of the shaft portion contacts with the connection portion. The metal terminal contains 97 wt % or more of Fe and 0.20 to 0.28 wt % of C. A length along the axial line of the shaft portion is not greater than 60 mm.

According to the first aspect, the metal terminal contains 97 wt % or more of Fe and 0.20 to 0.28 wt % of C, and the length along the axial line of the shaft portion is not greater than 60 mm. Occurrence of flexural buckling of the shaft portion subjected to a compressive force can be suppressed.

According to the second aspect based on the first aspect, the length along the axial line of the shaft portion is not smaller than 20 mm. As the shaft portion becomes shorter, the buckling load becomes greater, so that bending deformation becomes less likely to occur. However, since the length of the shaft portion is not smaller than 20 mm, bending deformation of the shaft portion can be ensured.

According to the third aspect based on the first or second aspect, the metal terminal contains 0.22 wt % or less of Cr. Workability of a material of the metal terminal can be ensured.

### BRIEF DESCRIPTION OF THE DRAWINGS

FIG. 1 is a one-sided sectional view of a spark plug according to an embodiment.

FIG. 2 is a graph illustrating an example of the relationship between the length of a test piece and a load when the test piece yielded.

### DETAILED DESCRIPTION OF THE INVENTION

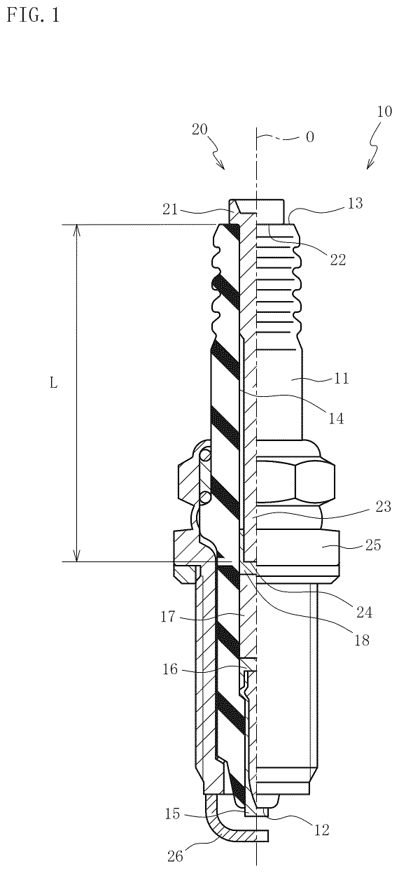

Hereinafter, a preferred embodiment of the present invention will be described with reference to the accompanying drawings. FIG. 1 is a one-side sectional view of the spark plug 10 in a first embodiment, with an axial line O as a boundary. In FIG. 1, the lower side of the sheet is defined as a front end side of the spark plug 10, and the upper side of the sheet is defined as a rear end of the spark plug 10. As shown in FIG. 1, the spark plug 10 includes an insulator 11, a center electrode 15, and a metal terminal 20.

The insulator 11 is a substantially cylindrical member made of ceramic such as alumina which is excellent in mechanical property and in insulation property under high temperature. The insulator 11 has an axial hole 14 provided along the axial line O and penetrating from a front end 12 to a rear end 13 of the insulator 11. The center electrode 15 is provided on the front end 12 side in the axial hole 14 of the insulator 11. The center electrode 15 protrudes from the front end 12 of the insulator 11.

The center electrode 15 is a conductive rod-shaped member made of metal. The center electrode 15 is formed such that a core material containing copper as a main component is coated with a bottomed cylindrical base material containing Ni as a main component, for example. The core material may be omitted. The center electrode 15 is fixed in the axial hole 14 of the insulator 11 by a first connection portion 16 which is conductive.

The first connection portion 16 contains an amorphous material and conductive powder. As the amorphous material, for example, a B₂O₃—SiO₂-based material, a BaO—B₂O₃-based material, or a SiO₂—B₂O₃—CaO—BaO-based material may be used. As the conductive powder, for example, carbon particles (carbon black, etc.), a non-metallic conductive material such as TiC particles or TiN particles, or metal such as Al, Mg, Ti, Zr, Cu, or Zn, may be used.

A resistor 17 is conductive and contacts with the first connection portion 16. The resistor 17 contains an amorphous material, ceramic powder, and conductive powder. As the amorphous material, for example, a B₂O₃—SiO₂-based material, a BaO—B₂O₃-based material, or a SiO₂—B₂O₃—CaO—BaO-based material may be used. As the ceramic powder, for example, TiO₂ or ZrO₂ may be used. As the conductive powder, for example, carbon particles (carbon black, etc.), a non-metallic conductive material such as TiC particles or TiN particles, or metal such as Al, Mg, Ti, Zr, or Zn may be used.

A second connection portion 18 is conductive and contacts with the resistor 17. The second connection portion 18 contains an amorphous material and conductive powder. As the amorphous material, for example, a B₂O₃—SiO₂-based material, a BaO—B₂O₃-based material, or a SiO₂—B₂O₃—CaO—BaO-based material may be used. As the conductive powder, for example, carbon particles (carbon black, etc.), a non-metallic conductive material such as TiC particles or TIN particles, or metal such as Al, Mg, Ti, Zr, Cu, or Zn may be used.

The metal terminal 20 has a head portion 21 located at the rear end 13 of the insulator 11, and a shaft portion 23 located in the axial hole 14 adjacently to a front end 22 of the head portion 21. The head portion 21 is a part to which a high-voltage cable (not shown) is connected. The shaft portion 23 has a rod shape having a round cross-section. The diameter on a front end 24 side of the shaft portion 23 is smaller than the inner diameter of the axial hole 14, and therefore there is a gap between the axial hole 14 and a part of the shaft portion 23 near the front end 24. The metal terminal 20 may be at least partially plated with a material containing Ni, Zn, or the like. In the present embodiment, a center part of the rear end of the head portion 21 is recessed.

The shaft portion 23 is thinner than the head portion 21, and a length L along the axial line O of the shaft portion 23 is not smaller than 20 mm and not greater than 60 mm. The front end 24 of the shaft portion 23 contacts with at least the second connection portion 18. The shaft portion 23 is fixed in the axial hole 14 of the insulator 11 by the second connection portion 18. In the present embodiment, the front end 24 of the shaft portion 23 is buried in the second connection portion 18. Therefore, the front end 24 of the shaft portion 23 and an outer periphery of the shaft portion 23 near the front end 24 contact with the second connection portion 18, so that the area of the interface between the shaft portion 23 and the second connection portion 18 becomes large and thus the joining strength increases. The metal terminal 20 is electrically connected to the center electrode 15 via the connection portions 16, 18 and the resistor 17.

A metal shell 25 is a substantially cylindrical member made of a conductive metal material (e.g., low-carbon steel). The metal shell 25 is provided around an outer periphery of the insulator 11. A ground electrode 26 is connected to the metal shell 25. The ground electrode 26 is a conductive member made of metal. A spark gap is provided between the ground electrode 26 and the center electrode 15.

The spark plug 10 is manufactured by the following method, for example. First, the center electrode 15 is placed in the axial hole 14 of the insulator 11 such that a front end of the center electrode 15 is located outside the axial hole 14. Next, material powder for the first connection portion 16 is put into the axial hole 14, to fill an area around a rear end of the center electrode 15. The material powder for the first connection portion 16 contains glass powder and conductive powder. After the material powder for the first connection portion 16 is put, the material powder in the axial hole 14 is preliminarily compressed using a rod member (not shown) for compression.

Next, material powder for the resistor 17 is put in the axial hole 14, to fill an area above the material powder of the first connection portion 16. The material powder for the resistor 17 contains glass powder, ceramic powder other than glass, and conductive powder. After the material powder for the resistor 17 is put, the material powder in the axial hole 14 is preliminarily compressed using a rod member (not shown) for compression. Next, material powder for the second connection portion 18 is put in the axial hole 14, to fill an area above the material powder of the resistor 17. The material powder for the second connection portion 18 contains glass powder and conductive powder. After the material powder for the second connection portion 18 is put, the material powder in the axial hole 14 is preliminarily compressed using a rod member (not shown) for compression.

In a welding process, the insulator 11 is put in a heating furnace (not shown), and the insulator 11 is heated to a temperature (800 to 1000° C.) higher than a glass transition point of the glass powder contained in each material powder in the axial hole 14, for example. The shaft portion 23 of the metal terminal 20 is inserted into the axial hole 14 from the rear end 13 of the insulator 11, and each material powder softened in the axial hole 14 by heating is compressed in the axial-line direction. At this time, a compressive force in the axial-line direction is applied to the shaft portion 23 of the metal terminal 20. By compressing each material powder in the axial hole 14 at high temperature, the connection portions 16, 18 and the resistor 17 are formed.

When the insulator 11 extracted from the heating furnace (not shown) is cooled, an amorphous material is solidified in the axial hole 14, so that the connection portions 16, 18 fix the resistor 17, the connection portion 16 fixes the center electrode 15 in the axial hole 14 of the insulator 11, and the connection portion 18 fixes the shaft portion 23 of the metal terminal 20 in the axial hole 14 of the insulator 11. After the metal terminal 20 is fixed to the insulator 11, the metal shell 25 with the ground electrode 26 connected thereto is attached to the insulator 11, and the ground electrode 26 is bent, thus obtaining the spark plug 10.

The material of the metal terminal 20 is low-carbon steel containing 0.20 to 0.28 wt % of C. In a case where the metal terminal 20 is plated, the material of the metal terminal 20 refers to a material of a part other than the plating. In the present embodiment, the head portion 21 and the shaft portion 23 are molded integrally by the same material.

The material of the metal terminal 20 may contain, in addition to Fe and C, at least one kind selected from Si, Mn, P, S, Cr, Cu, Ni, Mo, Al, Nb, Ti, V, and N, for example. Component analysis for the metal terminal 20 is based on JIS G0321: 2017. In the material of the metal terminal 20, the remainder other than the above elements is Fe and 97 wt % or more of Fe is contained. C improves the proof stress and the tensile strength of the metal terminal 20. If an extremely large amount of C is contained, the ductility is reduced, and therefore the content of C is 0.20 to 0.28 wt %.

Si acts as a deoxidizer, and meanwhile, Si solid-solves into ferrite, to increase the strength of the metal terminal 20. Preferably, the content of Si is not more than 0.5 wt %. The range not more than 0.5 wt % has no lower limit value defined and includes 0 wt %. 0 wt % means a value not more than a detection limit in analysis based on JIS G0321: 2017. The same applies to other elements for which lower limit values are not defined.

Mn acts as a deoxidizer, and meanwhile, Mn densifies pearlite, thus increasing the strength and the hardness of the metal terminal 20. Preferably, the content of Mn is 0.3-1.65 wt %. P and S readily segregate, thus reducing the toughness of the metal terminal 20. Preferably, the contents of P and S are not more than 0.04 wt %. Cr improves the oxidation resistance and the corrosion resistance of the metal terminal 20. If an extremely large amount of Cr is contained, workability of the material is reduced. Therefore, preferably, the content of Cr is not more than 0.22 wt %.

Cu, Ni, and Mo are effective for increasing the strength of the metal terminal 20. Al acts as a deoxidizer, and meanwhile, Al fines crystal grains, thus increasing the toughness of the metal terminal 20. Nb, Ti, and V fine crystal grains, thus increasing the toughness of the metal terminal 20. N produces nitrides with Nb, Ti, and V and fines crystal grains, thus increasing the toughness of the metal terminal 20. Adding Cu, Ni, Mo, Nb, Ti, and V might result in an excessively high quality of the metal terminal 20. Therefore, preferably, the total content of Cu, Ni, Mo, Nb, Ti, and V is not more than 0.5 wt %.

In the welding process, when the material powder in the axial hole 14 of the insulator 11 is compressed in the axial-line direction using the shaft portion 23 of the metal terminal 20, the shaft portion 23 receives a compressive load in the axial-line direction, thus elastically deforming. If the compressive load has become a critical value or greater, the shaft portion 23 becomes unstable in uniform-compression elastic deformation and becomes stable in bending deformation. There is variation in the volume and the filling density of the material powder in the axial hole 14, but owing to bending deformation (elastic deformation) of the shaft portion 23, the metal terminal 20 can be pushed into the axial hole 14 without breakage of the insulator 11 to a position where the front end 22 of the head portion 21 of the metal terminal 20 comes into contact with the rear end 13 of the insulator 11, irrespective of variations in the material powder in the axial hole 14. Thus, variation in the protruding length of the head portion 21 of the metal terminal 20 from the insulator 11 can be suppressed.

On the other hand, if the tensile strength of the shaft portion 23 is small, a buckling load is exceeded through bending deformation of the shaft portion 23, so that flexural buckling occurs in the shaft portion 23. Thus, compression of the material powder in the axial hole 14 might be insufficient, resulting in incomplete products of the connection portions 16, 18 and the resistor 17. On the other hand, if the tensile strength of the shaft portion 23 is great, bending deformation of the shaft portion 23 is small. Therefore, in a case where the volume or the filling density of the material powder in the axial hole 14 is great, the metal terminal 20 cannot be pushed into the axial hole 14 to a position where the front end 22 of the head portion 21 of the metal terminal 20 comes into contact with the rear end 13 of the insulator 11, so that the protruding length of the head portion 21 increases, or the insulator 11 is broken by the pressure of the material powder compressed between the metal terminal 20 and the center electrode 15. In addition, as the length L along the axial line O of the shaft portion 23 becomes greater, the buckling load becomes smaller, so that flexural buckling becomes more likely to occur.

In order to prevent these, the metal terminal 20 contains 97 wt % or more of Fe and 0.20 to 0.28 wt % of C, and the length L along the axial line O of the shaft portion 23 is not greater than 60 mm (not including 0 mm). Thus, without making the metal terminal 20 by an alloy steel containing Ni, Mo, Nb, Ti, V, etc., the proof stress, the tensile strength, and the buckling load of the metal terminal 20 can be ensured, and therefore the cost for the material of the metal terminal 20 can be reduced. In addition, in the welding process, when the material powder is compressed between the metal terminal 20 and the center electrode 15, flexural buckling of the shaft portion 23 due to a compressive force applied to the shaft portion 23 can be suppressed, and therefore the connection portions 16, 18 and the resistor 17 with the material powder sufficiently compressed can be obtained. Further, if the length L of the shaft portion 23 is not smaller than 20 mm, when the material powder is compressed between the metal terminal 20 and the center electrode 15 in the welding process, elastic deformation of the shaft portion 23 due to a compressive force applied to the shaft portion 23 can be ensured. Thus, variation in the protruding length of the head portion 21 of the metal terminal 20 from the insulator 11 and breakage of the insulator 11 due to the pressure of the compressed material powder can be suppressed.

### EXAMPLES

The present invention will be described in more detail using Examples. However, the present invention is not limited to the Examples.

An examiner produced various test pieces using materials (low-carbon steel) different in chemical composition, evaluated workability of the materials, and measured high-temperature bending strengths of the test pieces. The materials contained 0.07 to 0.30 wt % of C, 0.03 to 0.25 wt % of Cr, 0.1 to 0.35 wt % of Si, 0.30 to 0.60 wt % of Mn, less than 0.03 wt % of P, and less than 0.035 wt % of S, and the remainder was Fe.

### (Workability)

An examiner prepared various materials different in the contents of C and Cr and formed in a columnar shape with a diameter of 6 mm and a length of 10 mm, molded fifty of each material into a columnar test piece having a diameter of 3 mm through press work (cold forging) for a different forging time, and visually observed the outer periphery of each test piece. Workability was evaluated as A for the material of which all the fifty test pieces were not flawed in a case where the forging time was 2.5 seconds, B for the material of which all the fifty test pieces were not flawed in a case where the forging time was 3.0 seconds, and C for the material of which test pieces were flawed also in a case where the forging time was 3.0 seconds. Table 1 shows the relationship between evaluation and the contents of C and Cr in a material.

TABLE 1

| | | C (wt %) | | | | | | |
|---|---|---|---|---|---|---|---|---|
| Workability | | 0.07 | 0.18 | 0.20 | 0.22 | 0.25 | 0.28 | 0.30 |
| Cr | 0.03 | A | A | A | A | A | A | C |
| (wt %) | 0.15 | A | A | A | A | A | A | C |
| | 0.20 | A | A | A | A | A | A | C |
| | 0.22 | B | B | B | B | B | B | C |
| | 0.25 | C | C | C | C | C | C | C |

As shown in Table 1, workability of the materials containing 0.07 to 0.28 wt % of C and 0.03 to 0.20 wt % of Cr was evaluated as A.

### (High-Temperature Bending Test 1)

In a bending test (three-point bending test), test pieces were round rods having a diameter of 3 mm and made of various materials different in the contents of C and Cr, the inter-fulcrum distance was 70 mm, the atmosphere temperature was 900° C., and a test speed of an indenter pushing and bending each test piece was 5 mm/s. An examiner measured, for three test pieces, a strength (high-temperature bending strength) when each test piece yielded. A case where the average of measured values of the strength was not smaller than 0.5 kN was evaluated as A, a case where the average was not smaller than 0.4 kN but smaller than 0.5 kN was evaluated as B, and a case where the average was smaller than 0.4 kN was evaluated as C. A table 2 shows the relationship between evaluation and the contents of C and Cr in a material.

TABLE 2

| High- | | | | | | | | |
|---|---|---|---|---|---|---|---|---|
| temperature | | C (wt %) | | | | | | |
| bending strength | | 0.07 | 0.18 | 0.20 | 0.22 | 0.25 | 0.28 | 0.30 |
| Cr | 0.03 | C | B | A | A | A | A | A |
| (wt %) | 0.15 | C | B | A | A | A | A | A |
| | 0.20 | C | B | A | A | A | A | A |
| | 0.22 | C | B | A | A | A | A | A |
| | 0.25 | C | B | A | A | A | A | A |

As shown in Table 2, evaluation of the high-temperature bending strength was A for the materials containing 0.20 to 0.30 wt % of C and 0.03 to 0.25 wt % of Cr. When the workability and the high-temperature bending strength were comprehensively evaluated, the materials containing 0.20 to 0.28 wt % of C and 0.03 to 0.20 wt % of Cr were evaluated as A in workability and high-temperature bending strength.

### (High-Temperature Bending Test 2)

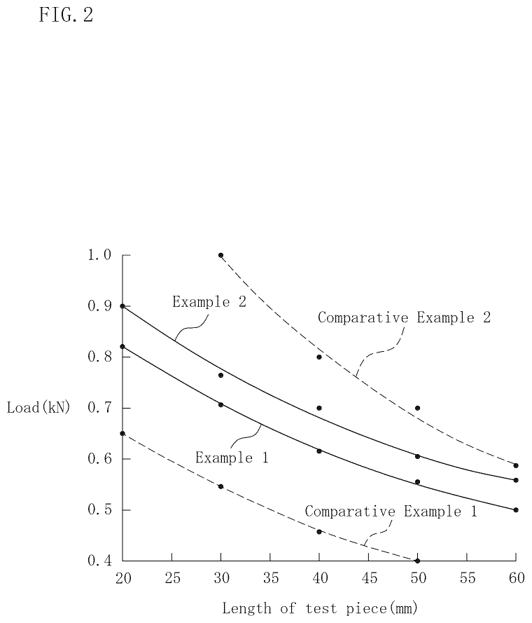

An examiner produced various test pieces formed as round rods having a diameter of 3 mm using materials in Examples 1 and 2 and Comparative Examples 1 and 2. The examiner measured, for three test pieces, a load when each test piece yielded, in the same manner as in the high-temperature bending test 1 except for setting the inter-fulcrum distance at 20 mm, 30 mm, 40 mm, 50 mm, and 60 mm. FIG. 2 is a graph plotting the relationship between the length (i.e., inter-fulcrum distance) of a test piece and a load (average value at n=3), for each material of the test pieces.

In FIG. 2, the material in Example 1 contained 0.22 wt % of C, 0.03 wt % of Cr, 0.19 wt % of Si, 0.40 wt % of Mn, 0.007 wt % of P, 0.01 wt % of S, 0.01 wt % of Cu, and 0.01 wt % of Ni, and the remainder was Fe. The material in Example 2 contained 0.28 wt % of C, 0.25 wt % of Cr, 0.20 wt % of Si, 0.38 wt % of Mn, 0.007 wt % of P, 0.01 wt % of S, 0.01 wt % of Cu, and 0.01 wt % of Ni, and the remainder was Fe.

In FIG. 2, the material in Comparative Example 1 contained 0.07 wt % of C, 0.25 wt % of Cr, 0.10 wt % of Si, 0.60 wt % of Mn, 0.007 wt % of P, 0.01 wt % of S, 0.01 wt % of Cu, and 0.01 wt % of Ni, and the remainder was Fe. The material in Comparative Example 2 contained 0.36 wt % of C, 1.09 wt % of Cr, 0.24 wt % of Si, 0.77 wt % of Mn, 0.013 wt % of P, 0.01 wt % of S, 0.01 wt % of Cu, and 0.02 wt % of Ni, and the remainder was Fe.

The length (inter-fulcrum distance) of each test piece in the high-temperature bending test 2 corresponds to the length L of the shaft portion 23 of the metal terminal 20 in the spark plug 10. According to a rule of thumb, it is known that, if a bending load on a test piece is not smaller than 0.5 kN, flexural buckling does not occur in the shaft portion 23 when the material powder in the axial hole 14 of the insulator 11 is compressed in the axial-line direction using the metal terminal 20 in the welding process of the spark plug 10. In addition, it is known that, if a bending load on a test piece is not greater than 0.9 kN, bending deformation (elastic deformation) occurs in the shaft portion 23 subjected to a compressive force in the welding process of the spark plug 10.

According to FIG. 2, among the test pieces in Comparative Example 1 containing 0.07 wt % of C, the one having a length greater than 35 mm exhibited a result that the load was smaller than 0.5 kN. According to the metal terminals made of the material in Comparative Example 1, it is inferred that, if the length L of the shaft portion exceeds 35 mm, there is a case where flexural buckling occurs in the shaft portion in the welding process, so that the connection portions and the resistor become incomplete.

Among the test pieces in Comparative Example 2 containing 0.36 wt % of C, the one having a length smaller than 35 mm exhibited a result that the load exceeded 0.9 kN. According to the metal terminals made of the material in Comparative Example 2, it is inferred that, if the length L of the shaft portion exceeds 35 mm, there is a case where the protrusion length of the head portion becomes longer or the insulator is broken in the welding process.

On the other hand, among the test pieces in Example 1 containing 0.22 wt % of C and the test pieces in Example 2 containing 0.28 wt % of C, the ones having lengths not greater than 60 mm exhibited a result that the load was not smaller than 0.5 kN. According to the metal terminals made of the materials in Examples 1 and 2, it is inferred that, if the length L of the shaft portion is not greater than 60 mm, flexural buckling does not occur in the shaft portion in the welding process. Among the test pieces in Examples 1 and 2, the ones having lengths not smaller than 20 mm exhibited a result that the load was not greater than 0.9 kN. According to the metal terminals made of the materials in Examples 1 and 2, it is inferred that, if the length L of the shaft portion is not smaller than 20 mm, bending deformation occurs in the shaft portion in the welding process.

While the present invention has been described above with reference to the embodiment, the present invention is not limited to the above embodiment at all. It can be easily understood that various modifications can be devised without departing from the gist of the present invention. For example, the shape of the metal terminal 20 shown above is merely an example and may be set as appropriate.

In the embodiment, it has been described that a center part of the rear end of the head portion 21 is recessed. However, the present invention is not limited thereto. As a matter of course, the rear end of the head portion 21 may not be recessed or a center part of the rear end of the head portion 21 may protrude.

In the embodiment, it has been described that the entire head portion 21 of the metal terminal 20 is thicker than the shaft portion 23. However, the present invention is not limited thereto. As a matter of course, the head portion 21 may be provided with a flange, the flange may be thicker than the shaft portion 23, the remaining part (hereinafter, referred to as “pin”) of the head portion other than the flange may be thinner than the flange, and the flange may be located at the rear end 13 of the insulator 11. The shaft portion 23 is molded integrally with the flange and the pin. In this case, the pin may be provided with a knurl or an external thread, or a cap as a part of the head portion may be put on the pin.

In a case of putting a cap on the pin, as a matter of course, the cap put on the pin may be plastically deformed so that the cap will not come off, or the cap may be provided with an internal thread to be fitted with the external thread of the pin so that the cap is attachable and detachable. A material of the cap may be different from a material of the shaft portion 23, the flange, and the pin, or may be the same material. The shaft portion 23, the flange, and the pin may be molded integrally with the cap.

In the embodiment, it has been described that the resistor 17 is provided in the axial hole 14 of the insulator 11. However, the present invention is not limited thereto. As a matter of course, the resistor 17 may not be provided. In a case of not providing the resistor 17, the second connection portion 18 is not provided and the shaft portion 23 contacts with the first connection portion 16 with which the center electrode 15 is welded in the axial hole 14. Thus, the center electrode 15 and the metal terminal 20 are electrically connected.

### DESCRIPTION OF REFERENCE NUMERALS

10 spark plug
11 insulator
12 front end
13 rear end
14 axial hole
15 center electrode
18 second connection portion (connection portion)
20 metal terminal
21 head portion
22 front end of head portion
23 shaft portion
24 front end of shaft portion
L length of shaft portion
O axial line

1. A spark plug comprising:
an insulator having an axial hole penetrating from a front end to a rear end along an axial line;
a center electrode provided on a front end side in the axial hole;
a metal terminal, comprising:
a head portion located at the rear end of the insulator; and
a shaft portion located in the axial hole adjacently to a front end of the head portion, the shaft portion being thinner than the head portion; and
a connection portion in contact with at least a front end of the shaft portion, the connection portion electrically connecting the center electrode and the metal terminal in the axial hole,
wherein the metal terminal contains 97 wt % or more of Fe and 0.20 to 0.28 wt % of C, and
wherein a length along the axial line of the shaft portion is not greater than 60 mm.

2. The spark plug according to claim 1, wherein the length is not smaller than 20 mm.

3. The spark plug according to claim 1, wherein the metal terminal contains 0.22 wt % or less of Cr.
